(19) United States
(12) Patent Application Publication
(10) Pub. No.: US 2026/0246354 A1
(43) Pub. Date: Aug. 20, 2026

(54) MAGNETIC GEAR

(71) Applicant: Mitsubishi Electric Corporation, Tokyo (JP)

(72) Inventors: Kodai OKAZAKI, Tokyo (JP); Junji KITAO, Tokyo (JP)

(73) Assignee: Mitsubishi Electric Corporation, Tokyo (JP)

(21) Appl. No.: 18/869,865

(22) PCT Filed: Jun. 9, 2022
(86) PCT No.: PCT/JP2022/023312

§ 371 Date: Nov. 27, 2024

(51) Int. Cl. H02K 51/00; H02K 1/24

(52) U.S. Cl. CPC H02K 51/00; H02K 1/24

(57) ABSTRACT

This magnetic gear comprises a magnetic gear part in which each of a multi-pole mechanism, a fewer-pole mechanism, and a polepiece shares a function of any one of a stator, a first rotor, and a second rotor. A positional relationship of magnetic poles is different such that at least one of the multi-pole mechanism, the fewer-pole mechanism, and the polepiece has a phase difference between adjacent sections among a plurality of sections divided along an axial direction. At least one of a greatest common divisor of the number of poles of the multi-pole mechanism and the polepiece and a greatest common divisor of the number of poles of the fewer-pole mechanism and the polepiece is 1 or 2.

### TECHNICAL FIELD

The present application relates to a magnetic gear.

### BACKGROUND ART

In a typical rotating electrical machine configured with permanent magnets and soft magnetic materials, as the rotation speed increases, an induced voltage increases and an input voltage that can be used for torque output decreases. Therefore, a decrease in the torque and a decrease in efficiency due to an increase in iron loss occur. Therefore, in order to obtain a desired output and efficiency characteristics, a drive unit is typically configured by combining a rotating electrical machine and a gear so that the rotation speed of the rotating electrical machine falls within an appropriate range.

As a gear to be used, a mechanical gear that has a meshing structure of mechanical gears is widely used. However, in recent years, a magnetic gear that enables power transmission in a non-contact manner without using a mechanical gear has been increasingly used. The magnetic gear of the old system has a configuration in which teeth of a mechanical gear are simply replaced with permanent magnets. However, since the magnetic gear enables acceleration and deceleration in a non-contact manner using an attractive force and a repulsive force of a magnetic force, vibration and noise are small, and improvement in maintainability is expected.

However, in the transmission of the torque by permanent magnets, since only the magnets facing each other contribute to the torque transmission, the torque is small as compared with the mechanical gear. In contrast, a magnetic gear of a new type called a flux-modulated type magnetic gear configured to increase an amount of magnetic flux contributing to transmission of torque in a structure to increase the torque is adopted. The flux-modulated type magnetic gear is constituted by a multi-pole mechanism and a fewer-pole mechanism in which the permanent magnets are concentrically arranged such that their polarities are alternately reversed and the arrangement surfaces thereof face each other with a gap therebetween, and is constituted by a plurality of magnetic pole pieces made of a soft magnetic material or the like called a polepiece arranged at an equal interval in the gap.

Although the flux-modulated type magnetic gear can improve the transmission torque, since the soft magnetic material is periodically arranged at a position extremely close to a permanent magnet, periodic vibration is generated by the electromagnetic excitation force or the cogging torque by the same principle as that of the rotating electrical machine. Therefore, there are concerns about electromagnetic noise due to vibration of the stator and the frame of the rotating electrical machine, adverse effects on a load at a connection destination due to vibration transmitted to the output shaft, and worsening in the controllability. On the other hand, there has been proposed a structure in which permanent magnets provided in a rotor of a magnetic gear are continuously skewed in an axial direction, and the cogging torque generated in each of cross sections in the axial direction of the magnetic gear is canceled due to a phase relationship (for example, refer to Patent Document 1).

### PRIOR ART DOCUMENT

### Patent Document

Patent Document 1: International Publication of Unexamined Application No. WO2015/053005 (paragraphs 0020 to 0033, FIG. 1 to FIG. 4)

### SUMMARY OF INVENTION

### Problems to be Solved by Invention

However, the structure in which the permanent magnets are continuously skewed in the axial direction has a problem of an increase in the manufacturing cost because a dedicated manufacturing facility is required for manufacturing the permanent magnets to have a special shape and combining the permanent magnets with the rotor core. On the other hand, in a case where the cogging torque is reduced without adopting the skew structure, a method is considered in which the number of poles of the magnetic gear is such that the order of the cogging torque increases. However, it is necessary to increase the least common multiple of the number of pole pieces of the magnetic gear and the number of permanent magnets of the multi-pole mechanism while a practical gear ratio is maintained, and in such a configuration, there is a problem in that electromagnetic noise due to the electromagnetic excitation force increases owing to a decrease in the order.

The present application has been made to solve the above-described problems, and an object of the present application is to obtain a flux-modulated type magnetic gear that achieves both a reduction in the cogging torque and a reduction in the electromagnetic excitation force without increasing the manufacturing cost.

### Means for Solving the Problems

The magnetic gear disclosed in the present application includes a magnetic gear part configured such that each of a multi-pole mechanism, a fewer-pole mechanism, and a polepiece shares a function of any one of a stator, a first rotor, and a second rotor, the multi-pole mechanism having magnetic poles of first pole numbers arranged along a circumferential direction with permanent magnets, the fewer-pole mechanism having magnetic poles of second pole numbers that are fewer than those of the first pole numbers and are arranged along the circumferential direction with permanent magnets, the polepiece having magnetic poles of third pole numbers arranged along the circumferential direction with soft magnetic material through magnetic gaps with respect to each of the magnetic poles of the multi-pole mechanism and of the fewer-pole mechanism; a first shaft to transmit torque between the first rotor and an outside; and a second shaft to transmit torque between the second rotor and an outside. In the magnetic gear part, between adjacent sections among a plurality of sections divided along an axial direction, a positional relationship of magnetic poles among the multi-pole mechanism, the fewer-pole mechanism, and the polepiece is different such that at least one of the multi-pole mechanism, the fewer-pole mechanism, and the polepiece has a phase difference, and at least one of a greatest common divisor of the first pole numbers and the third pole numbers and a greatest common divisor of the second pole numbers and the third pole numbers is 1 or 2.

### Advantageous Effect of Invention

According to the magnetic gear disclosed in the present application, it is possible to obtain a flux-modulated type magnetic gear that achieves both a reduction in the cogging torque and a reduction in the electromagnetic excitation force without increasing the manufacturing cost.

### BRIEF DESCRIPTION OF THE DRAWINGS

FIG. 1 is a cross-sectional view taken along a rotation axis showing a configuration of a magnetic gear according to Embodiment 1.

FIG. 2A and FIG. 2B are cross-sectional views perpendicular to the rotation axis of a first section and a second section, respectively, of a magnetic gear part with a two-stage structure constituting the magnetic gear according to Embodiment 1.

FIG. 3A and FIG. 3B are diagrams showing relationships of an x-component of an electromagnetic excitation force and a y-component of the electromagnetic excitation force respectively, with respect to a rotation angle as a reference to a multi-pole mechanism in a magnetic gear part of the magnetic gear according to Embodiment 1.

FIG. 4 is a vector diagram of an electromagnetic excitation force generated in the multi-pole mechanisms in the first section and the second section of the magnetic gear according to Embodiment 1.

FIG. 5A and FIG. 5B are a cross-sectional view perpendicular to the rotation axis in the magnetic gear in the second section and a vector diagram of the electromagnetic excitation force generated in the multi-pole mechanism, respectively, according to a variation example of Embodiment 1.

FIG. 6A and FIG. 6B respectively show a relationship between a circumferential position of the multi-pole mechanism of the magnetic gear and the first order component of the electromagnetic excitation force, and a relationship between a phase difference of the two sections and an amplitude of the first order component of the electromagnetic excitation force of an entire magnetic gear part according to the variation example of Embodiment 1.

FIG. 7 is a cross-sectional view taken along the rotation axis, showing a configuration of a magnetic gear according to Embodiment 2.

FIG. 8 is a cross-sectional view perpendicular to the rotation axis in the second section of the magnetic gear according to Embodiment 2.

FIG. 9A and FIG. 9B are diagrams showing relationships of the x-component of the electromagnetic excitation force and the y-component of the electromagnetic excitation force, respectively, with respect to the rotation angle as a reference to the multi-pole mechanism in the magnetic gear part of the magnetic gear according to Embodiment 2.

FIG. 10 is a cross-sectional view taken along the rotation axis, showing a configuration of a magnetic gear according to Embodiment 3.

FIG. 11 is a cross-sectional view taken along the rotation axis, showing a configuration of a magnetic gear according to Embodiment 4.

FIG. 12 is a cross-sectional view taken along the rotation axis, showing a configuration of a magnetic gear according to Embodiment 5.

FIG. 13 is a cross-sectional view taken along the rotation axis, showing a configuration of a magnetic gear according to Embodiment 6.

FIG. 14A and FIG. 14B are cross-sectional views perpendicular to the rotation axis of the first section and the second section, respectively, of a magnetic gear part with the two-stage structure constituting the magnetic gear according to Embodiment 6.

FIG. 15 is a diagram showing a relationship between the circumferential position in a magnetic gap between a multi-pole mechanism and a polepiece, and the second order component of the electromagnetic excitation force in the magnetic gear according to Embodiment 6.

FIG. 16A and FIG. 16B respectively show a relationship between the circumferential position in a magnetic gap between the multi-pole mechanism and the polepiece of the magnetic gear, and the second order component of the electromagnetic excitation force, and a relationship between a phase difference of the two sections and an amplitude of the second order component of the electromagnetic excitation force according to a variation example of Embodiment 6.

FIG. 17 is a cross-sectional view taken along the rotation axis, showing a configuration of a magnetic gear according to Embodiment 7.

FIG. 18A and FIG. 18B are cross-sectional views perpendicular to the rotation axis of the first section and the second section, respectively, in a magnetic gear part with the two-stage structure constituting the magnetic gear according to Embodiment 7.

### MODE FOR CARRYING OUT INVENTION

### Embodiment 1

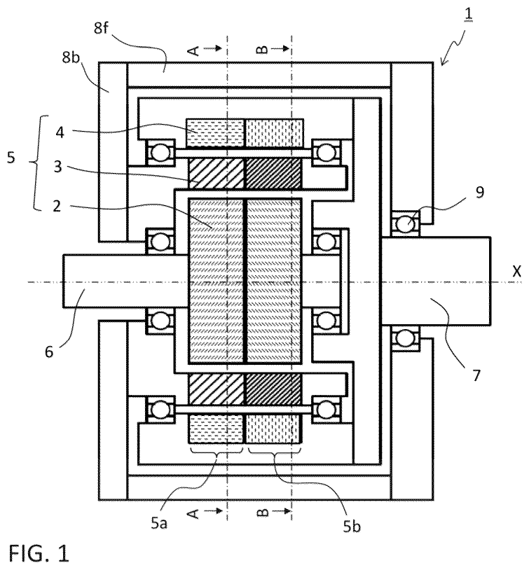

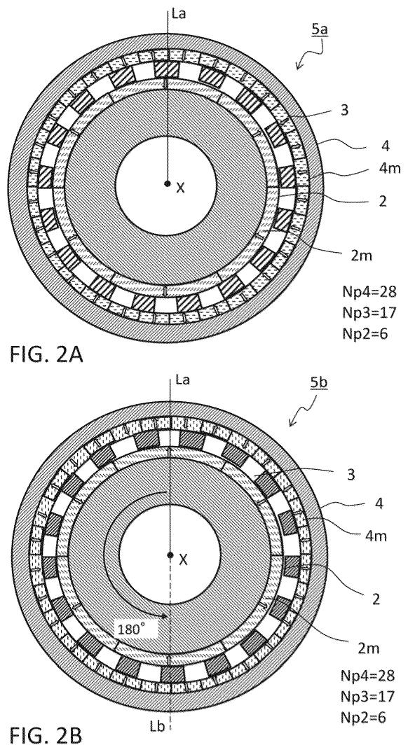

FIG. 1 to FIG. 4 are diagrams for describing a configuration and an operation of a magnetic gear according to Embodiment 1, FIG. 1 is a cross-sectional view that is taken along a rotation axis, includes the rotation axis, and shows the configuration of the magnetic gear, FIG. 2A is a cross-sectional view that is perpendicular to the rotation axis and corresponds to a line A-A of FIG. 1 in a first section of a magnetic gear part with a two-stage structure having different specifications in an axial direction, and FIG. 2B is a cross-sectional view that is perpendicular to the rotation axis and corresponds to a line B-B of FIG. 1 of a second section. Note that, in FIG. 1, in order to emphasize portions made of a magnetic material that generate a gear action of the magnetic gear part, other components are drawn without hatching although they are cross-sections, and hereinafter, cross-sectional views taken along the rotation axis are drawn in the same manner.

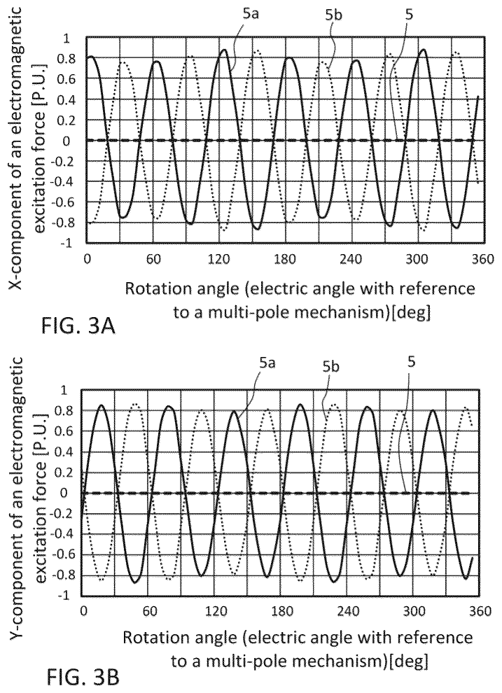

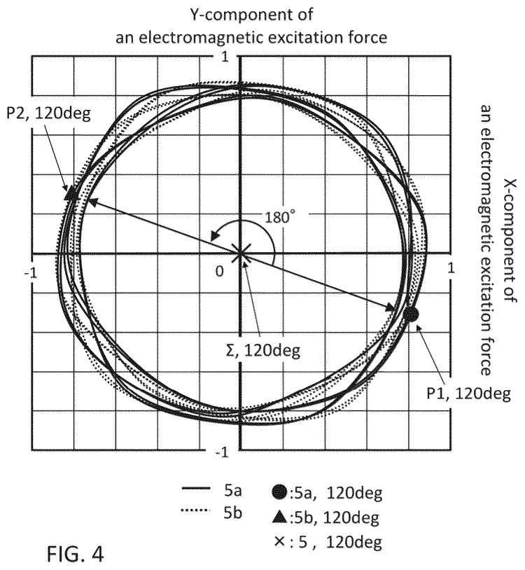

FIG. 3A shows a relationship between x-components of electromagnetic excitation forces (in PU units) of the first section, the second section, and an entire gear section with respect to an angle of rotation in an electric angle with reference to a multi-pole mechanism in the magnetic gear part, FIG. 3B shows a relationship between y-components of the electromagnetic excitation forces (in PU units) of the first section, the second section, and the entire gear part with respect to the angle of rotation in the electric angle with reference to the multi-pole mechanism in the magnetic gear part, and FIG. 4 is a vector diagram of the electromagnetic excitation force generated in the multi-pole mechanisms in the first section and the second section.

The magnetic gear of the present application in Embodiment 1 has two rotors and one stator as the flux-modulated type magnetic gear, and each of the rotors and the stator correspond to any one of the multi-pole mechanism, a fewer-pole mechanism, and a polepiece. Specifically, as shown in FIG. 1, an example will be described in which a magnetic gear part 5 is configured by concentrically arranging the fewer-pole mechanism 2 that is a first rotor on a side close to a rotation axis X, the multi-pole mechanism 4 that is a second rotor and is outside the fewer-pole mechanism 2 with a gap therebetween, and the polepiece 3 that is a stator in the gap.

In the magnetic gear part 5, between a first section 5a and a second section 5b, each of the multi-pole mechanism 4, the fewer-pole mechanism 2, and the polepiece 3 is mechanically connected in the direction of the rotation axis X (axial direction). On the other hand, the arrangement of the three mechanisms (the multi-pole mechanism 4, the fewer-pole mechanism 2, and the polepiece 3) in the first section 5a and the arrangement of the three mechanisms in the second section 5b are set such that the phase relation of one mechanism with respect to at least another mechanism of the three mechanisms is different between the first section 5a and the second section 5b. As a result, the magnetic gear part 5 forms a step skew between the first section 5a and the second section 5b, but a detailed configuration including the circumferential arrangement of the multi-pole mechanism 4, the fewer-pole mechanism 2, and the polepiece 3 will be described later.

The rotors (multi-pole mechanism 4 and fewer-pole mechanism 2) of the magnetic gear 1 are each supported by a plurality of bearings 9. Portion (hatching) constituted by a magnetic material and generating the gear action is protected by a bracket 8b and a frame 8f constituted by a structural member made of an iron, a non-magnetic material or the like. With these structures, a driving force generated by a rotating electrical machine (not shown) connected to a few-pole rotor shaft 6 on one end side or a multi-pole rotor shaft 7 on the other end side along the rotation axis X (axial direction) is reduced in speed and increased in torque or increased in speed and reduced in torque by the magnetic gear part 5 and is transmitted from the shaft on the opposite side.

### <Magnetic Gear Part>

A basic configuration of the magnetic gear part 5 will be described with reference to FIG. 2A in which a cross section perpendicular to the rotation axis X in the first section 5a is drawn. The magnetic gear 1 is constituted by concentrically arranging the multi-pole mechanism 4 provided with permanent magnets, the fewer-pole mechanism 2 having the number of poles fewer than that of the multi-pole mechanism 4, and the polepiece 3 made of a soft magnetic material arranged with respect to them via a magnetic gap portion. Permanent magnets 4m and permanent magnets 2m serving as magnetic poles are magnetized in the radial direction, and are arranged such that the polarities of the permanent magnets adjacent to each other in the circumferential direction are reversed (N, S, N, S, . . . : arrows in the figure), similarly to the rotating electrical machine.

The number of the permanent magnets 2m (the number of poles Np2) in the fewer-pole mechanism 2 is 6, the number of the permanent magnets 4m (the number of poles Np4) in the multi-pole mechanism 4 is 28, and the polepiece 3 is constituted by 17 magnetic pole pieces (the number of poles Np3=17). That is, a gear ratio of the magnetic gear part 5 in the magnetic gear 1 of Embodiment 1 is (28/2)/(6/2) that is 4.67, and a rotational force of the few-pole rotor shaft 6 is reduced to 1/4.67 times and a torque is increased to 4.67 times to be output to the multi-pole rotor shaft 7.

The greatest common divisor of the number of poles Np2 in the fewer-pole mechanism 2 and the number of poles Np3 in the polepiece 3, and the greatest common divisor of the number of poles Np4 in the multi-pole mechanism 4 and the number of poles Np3 in the polepiece 3 are both 1. As a result, the order of a cogging torque in the fewer-pole mechanism 2 or the polepiece 3, which is determined by the least common multiple of the number of poles Np2 in the fewer-pole mechanism 2 and the number of poles Np3 in the polepiece 3, can be increased. In addition, the order of the cogging torque in the multi-pole mechanism 4 or the polepiece 3, which is determined by the least common multiple of the number of poles Np4 in the multi-pole mechanism 4 and the number of poles Np3 in the polepiece 3, can also be increased.

Since it is known that the cogging torque typically decreases in magnitude as the order increases, the cogging torque generated in the magnetic gear 1 can be reduced by adopting such a configuration of the number of poles (number of poles Np2, number of poles Np3, number of poles Np4). As a result, a torque pulsation of the input shaft and the output shaft of the magnetic gear 1 can be suppressed, and the controllability of the rotating electrical machine and the load that are connected to the magnetic gear 1 can be improved.

On the other hand, since the greatest common divisor is 1, the spatial symmetry is one cycle (the first order in the spatial order) in the mechanical angle, and the electromagnetic excitation force of the first order in the spatial order is generated in each of the multi-pole mechanism 4, the fewer-pole mechanism 2, and the polepiece 3. The electromagnetic excitation force of the first order in the spatial order causes the bearing 9 or the frame 8f to vibrate at a low frequency, and thus becomes a factor of increasing noise and vibration, but these can be reduced by forming the magnetic gear part 5 such that a plurality of sections (the first section 5a and the second section 5b) having different phases in the axial direction are connected, which will be described in detail later.

Further, since the sections having the different phases are connected along the axial direction, in the permanent magnets 2m and the permanent magnets 4m used in each of the sections (the first section 5a and the second section 5b), surfaces extending in the axial direction are all parallel to the axial direction, and thus the shape is simplified (in the present embodiment, the shape is a tile shape). Therefore, unlike the case where the continuous skew is formed, mass production is easy and the manufacturing cost can be reduced.

Next, a difference in arrangement (phase) between the first section 5a and the second section 5b will be described. Here, a line segment La is defined as a reference position in the circumferential direction in the first section 5a in FIG. 2A. The line segment La indicates a direction of one arbitrary position in the circumferential direction at the time when the multi-pole mechanism 4, the fewer-pole mechanism 2, and the polepiece 3 in the first section 5a are in the positional relationship (phase relationship) shown in FIG. 2A. In the figure, for convenience, a direction right above the figure is defined as the line segment La.

The arrangement of the multi-pole mechanism 4, the fewer-pole mechanism 2, and the polepiece 3 in the second section 5b at the same time as when the first section 5a is arranged as shown in FIG. 2A is shown in FIG. 2B. The second section 5b has a configuration in which the arrangement of the first section 5a is rotated anticlockwise by 180 degrees up to a line segment Lb with reference to the line segment La. When the phases of the multi-pole mechanism 4, the fewer-pole mechanism 2, and the polepiece 3 are compared with those of the first section 5a, the phase of the multi-pole mechanism 4 coincides with that of the first section 5a, and the arrangement are the same. In contrast, in the configuration, the fewer-pole mechanism 2 and the polepiece 3 have different phases and thus the cross-sectional shape is different. That is, the multi-pole mechanism 4 forms the step skew between the first section 5a and the second section 5b.

The mechanism in phase with the first section 5a does not require the stacking in the axial direction with a phase shift and manufacturing equipment can be shared with the first section 5a. Therefore, the manufacturing equipment for the stacking with the phase shift is unnecessary, and an increase in manufacturing cost can be suppressed. This effect is generally obtained such that a section in which at least one of the polepiece 3, the fewer-pole mechanism 2, and the multi-pole mechanism 4 has a different phase is arranged for two or more sections in the axial direction.

Next, the operation and characteristics of the magnetic gear 1 including the above-described magnetic gear part 5 with the two-stage structure will be described. The x-component and the y-component of the electromagnetic excitation force generated in the multi-pole mechanism 4 of each of the first section 5a and the second section 5b that constitute the magnetic gear part 5 of the magnetic gear 1 according to Embodiment 1 are as shown in FIG. 3A and FIG. 3B. It can be seen that when a rotation is made by one cycle (360 degrees) in the electrical angle with the magnetic pole of the multi-pole mechanism 4 as a reference, there are components that oscillate in the same cycle in an x-axis direction and a y-axis direction.

That is, as described above, it can be seen that the electromagnetic excitation force of one cycle (the first order in the spatial order) in the mechanical angle with respect to the circumferential direction of the multi-pole mechanism 4 is generated in each of the first section 5a and the second section 5b. Since the first section 5a and the second section 5b have a relationship of being rotated in the arrangement by the mechanical angle of 180 degrees, the phases of the electromagnetic excitation forces of the first order in the spatial order are also rotated by 180 degrees, and the phases of the x-component and the y-component are inverted as shown in the figure. As a result, it can be seen that a value obtained by adding the electromagnetic excitation forces of the first section 5a and the second section 5b, that is, the electromagnetic excitation force of the entire magnetic gear part 5 is hardly generated.

The relationship between the x-component and the y-component at the rotation angle of 120 degrees in FIG. 3A and FIG. 3B is represented by a vector diagram as shown in FIG. 4. In FIG. 4, the trajectories of the vectors for the first section 5a and the second section 5b r are indicated by a solid line and a dotted line, respectively. The vectors of the electromagnetic excitation forces at the rotation angle of 120 degrees are inverted by 180 degrees between the first section 5a and the second section 5b. Therefore, when they are added together (the magnetic gear part 5) it becomes substantially 0, and it can be seen that the electromagnetic excitation forces are canceled by the electromagnetic forces having the same magnitude and the reversed vectors and thus no electromagnetic excitation force is generated.

Since the vectors of the electromagnetic excitation forces of the first section 5a and the second section 5b rotate along the trajectories while the phase relation of 180 degrees is maintained, it is understood that the suppression effect of the electromagnetic excitation force is maintained during one rotation of one cycle in the electrical angle. That is, the effect of suppressing the electromagnetic excitation force is maintained even during one rotation of one cycle in the mechanical angle (in the present embodiment, since the number of poles Np4 is 28, this corresponds to 14 cycles in the electrical angle).

In view of the above-described pole number relationship, it is possible to implement a configuration in which the effect of suppressing the electromagnetic excitation force is achieved while the cogging torque is suppressed, and it is possible to achieve both improvement in controllability of the rotating electrical machine and the load that are connected to the magnetic gear 1 and the reduction in vibration and noise caused by the electromagnetic excitation force of the magnetic gear 1.

### Variation Example

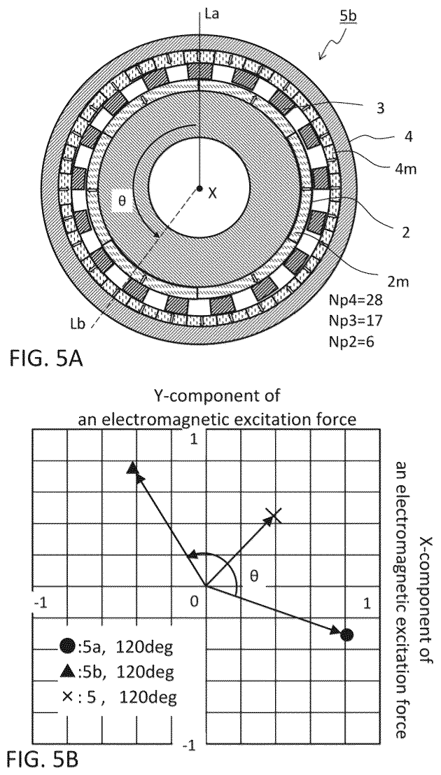

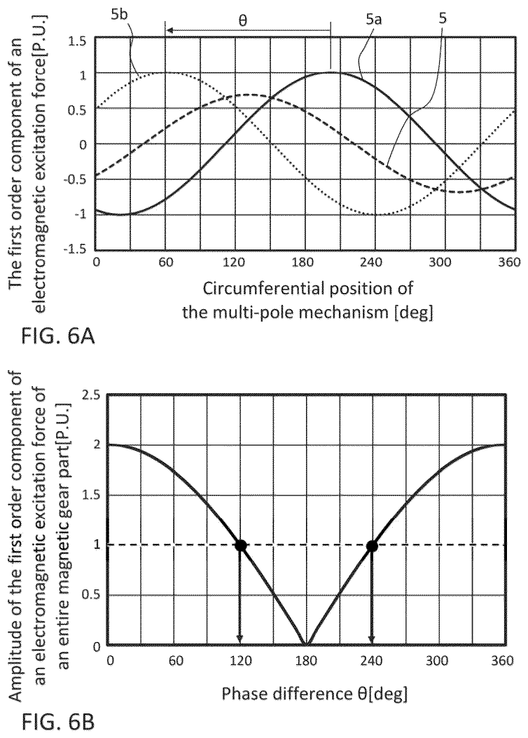

FIG. 5A is a cross-sectional view that is perpendicular to the rotational axis and corresponds to FIG. 2B in the second section in a magnetic gear according to a variation example of Embodiment 1, FIG. 5B is a vector diagram of the electromagnetic excitation force generated in the multi-pole mechanism, FIG. 6A is a diagram showing a relationship between the circumferential position and the first order component of the electromagnetic excitation force in the multi-pole mechanism of the magnetic gear, and FIG. 6B is a diagram showing a relationship between the phase difference (phase shift) of the two sections and the amplitude of the first order component of the electromagnetic excitation force of the entire magnetic gear part.

The present variation example is the same as that described in Embodiment 1 except that the arrangement in the second section is different, and the first section has the arrangement described with reference to FIG. 2A. As shown in FIG. 5A, the second section 5b of the magnetic gear 1 according to the variation example is such that the arrangement is rotated from the first section 5A up to the line segment Lb by the phase shift θ with reference to the line segment La. That is, the case where θ is 180 degrees corresponds to the arrangement shown in FIG. 2B described in Embodiment 1, and the present variation example shows a configuration in which the rotation angle is generalized.

The relationship between the vectors of the electromagnetic excitation forces is such that the first section 5a and the second section 5b have a phase difference θ as shown in FIG. 5B. Then, it is understood that the electromagnetic excitation force of the entire magnetic gear part 5, which is indicated by the added vector, varies depending on the difference in the phase between the first section 5a and the second section 5b.

The relationship between the first order component of the electromagnetic excitation force represented by the addition of the vectors is shown in FIG. 6A as a distribution of the electromagnetic forces at the circumferential positions of the multi-pole mechanism 4. Similarly to the notation of the vector diagram, it can be seen that the amplitude of the waveform (5: broken line) indicating the addition of the first order components in the spatial order of the electromagnetic excitation forces varies owing to the phase difference between the first section 5a and the second section 5b.

In the case where the arrangement of the second section 5b is shifted in phase from that of the first section 5a by the phase shift θ on the mechanical angle basis, the waveform obtained by adding that of the first section 5a and that of the second section 5b, that is, the relationship between the amplitude of the first order component of the electromagnetic excitation force of the entire magnetic gear part 5 and the phase shift θ is shown in FIG. 6B. When the phase shift θ is in the range of more than 120 degrees and less than 240 degrees, the amplitude of the first order component of the electromagnetic excitation force can be made smaller than that generated by each of the first section 5a and the second section 5b alone. That is, it is possible to obtain the effect of providing the magnetic gear 1 with lower noise than in the case where one magnetic gear part is constituted by a single section.

### Another Variation Example

In Embodiment 1 and the variation example thereof (the above-described example), the example in which the phases of the multi-pole mechanisms 4 coincide with each other in the cross section rotated by 180 degrees between the first section 5a and the second section 5b has been described, but this is not a limitation. For example, also in the case where the phases of the fewer-pole mechanism 2 or the polepiece 3 coincide with each other by the rotation of 180 degrees, it is possible to reduce the steps for stacking each of the mechanisms in the second section 5b and shifting the phase with respect to the arrangement of the first section 5a, and the same effect of reducing the manufacturing cost can be obtained.

Further, in each of the above examples, the example in which the polepiece 3 is fixed has been described. However, the polepiece 3 may be configured to be freely rotatable and the phase may be freely adjusted. Further, the multi-pole mechanism 4 or the fewer-pole mechanism 2 may be fixed. Further, in each of the above-described examples, the example in which the two kinds of sections (the first section 5a and the second section 5b) are connected in the axial direction has been described. However, the same effect can be obtained in a configuration in which more kinds of sections are combined to cancel the electromagnetic excitation forces by the addition of vectors.

### Embodiment 2

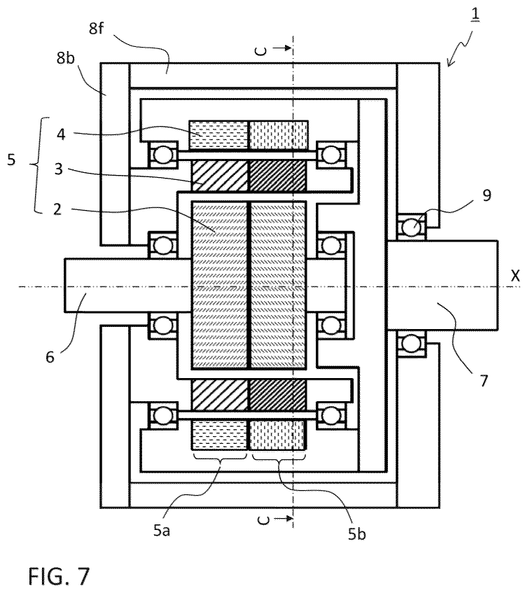

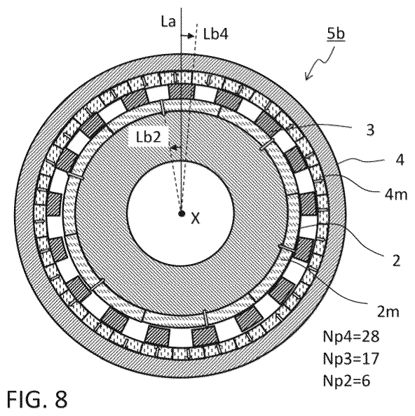

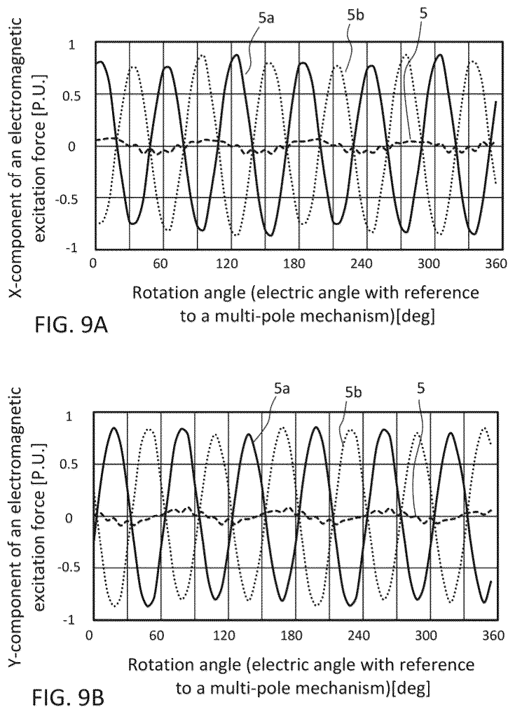

In Embodiment 2, the arrangement of the mechanisms in the second section is changed with respect to Embodiment 1. FIG. 7, FIG. 8, FIG. 9A, and FIG. 9B are for describing a configuration and an operation of a magnetic gear according to Embodiment 2, FIG. 8 is a cross-sectional view that is along the rotation axis, includes the rotation axis, and shows the configuration of the magnetic gear, and FIG. 8 is a cross-sectional view that is perpendicular to the rotation axis in the second section and corresponds to a line C-C of FIG. 7. FIG. 9A is a diagram showing a relationship of the x-components of the electromagnetic excitation forces of the first section, the second section, and the entire gear part with respect to the rotation angle in the electrical angle with reference to the multi-pole mechanism in the magnetic gear part, and FIG. 9B is a diagram showing a relationship of the y-components of the electromagnetic excitation forces of the first section, the second section, and the entire gear part with respect to the rotation angle in the electrical angle with reference to the multi-pole mechanism in the magnetic gear part.

The magnetic gear 1 according to Embodiment 2 is the same as that of Embodiment 1 except that the arrangement configuration of the mechanisms in the second section 5b described in Embodiment 1 is replaced, and FIG. 2A of Embodiment 1 is referred to. The second section 5b is arranged so as to be advanced in phase in the lapse of time of the first section 5a so as to be in a phase relation in which cancelation can be made by the addition with the first order component of the electromagnetic force of the first section 5a.

As shown in FIG. 7 and FIG. 8, the second section 5b is arranged so as to be rotated by 30 degrees in the electrical angle with reference to the multi-pole mechanism 4 with respect to the first section 5a described using FIG. 2A. When a time has elapsed for rotation by 30 degrees in the electrical angle with reference to the multi-pole mechanism 4, a direction in which the multi-pole mechanism 4 rotates from the line segment La is denoted by Lb4, and a direction in which the fewer-pole mechanism 2 rotates from the line segment La is denoted by Lb2. Thus, at the time for the rotation by 30 degrees in the electrical angle with reference to the multi-pole mechanism 4 with respect to the line segment La in the first section 5a, the multi-pole mechanism 4 rotates to the position of the line segment Lb4, and the fewer-pole mechanism 2 rotates to the position of the line segment Lb4.

To be specific, as shown in FIG. 8, the multi-pole mechanism 4 and the fewer-pole mechanism 2 are rotated so as to be positioned at the line segment Lb4 and the line segment Lb2, respectively, with reference to the line segment La of the first section 5a. As shown in FIG. 9A and FIG. 9B, the configuration is such that the x-component and the y-component of the electromagnetic excitation forces of the first section 5a and the second section 5b cancel each other out, and the electromagnetic excitation force becomes smaller than that of the single section. As described above, even when the second section 5a having the arrangement obtained by rotating the arrangement with respect to the first sections 5b in the lapse of time are connected along in the axial direction, the same effect as that of Embodiment 1 can be obtained.

### Variation Example

In Embodiment 2, since the polepiece 3 is fixed, and thus the example in which the phase of the polepiece 3 coincides with each other in the first section 5a and the second section 5b is shown. However, it is obvious that the same effect can be obtained even in a case where the multi-pole mechanism 4 or the fewer-pole mechanism 2 is fixed, and the other two mechanisms are freely rotatable.

In FIG. 8, the second section 5b is configured to have the arrangement at the time for rotation by 30 degrees in the electrical angle with reference to the multi-pole mechanism 4 with respect to the arrangement of the first section 5a, but this is not a limitation. It is obvious that a similar effect can be obtained even when the second section 5b is configured to have an arrangement at the time for rotation by another electrical angle that enables cancellation of vibration due to the electromagnetic excitation force.

For example, a case where the arrangement of each mechanism in the second section 5b at this time is an arrangement at a time for rotation by a degrees (0≤α≤360) in the electrical angle with reference to the multi-pole mechanism 4 with respect to the first section 5a will be exemplified. That is, at the time for rotation by a degrees in the electrical angle with reference to the multi-pole mechanism 4 has elapsed, a direction in which the multi-pole mechanism 4 rotates from the line segment La is defined as Lb4, and a direction in which the fewer-pole mechanism 2 rotates from the line segment La is defined as Lb2. Thus, with reference to the line segment La in the first section 5a, at the time for rotation by a degrees in the electrical angle with reference to the multi-pole mechanism 4, the multi-pole mechanism 4 can be configured to rotate to the position of the line segment Lb4 and the fewer-pole mechanism 2 can be configured to rotate to the position of the line segment Lb4.

In Embodiment 2 including the variation example, the example in which the polepiece 3 is fixed has been described. However, the polepiece 3 may be configured to be freely rotatable, and thus the phase can be freely adjusted. Further, the multi-pole mechanism 4 or the fewer-pole mechanism 2 may be fixed. In addition, in Embodiment 2, the example in which two types of sections (the first section 5a and the second section 5b) are connected in the axial direction has been described. However, the same effect can be obtained by combining more kinds of sections to cancel the electromagnetic excitation forces by adding vectors.

### Embodiment 3

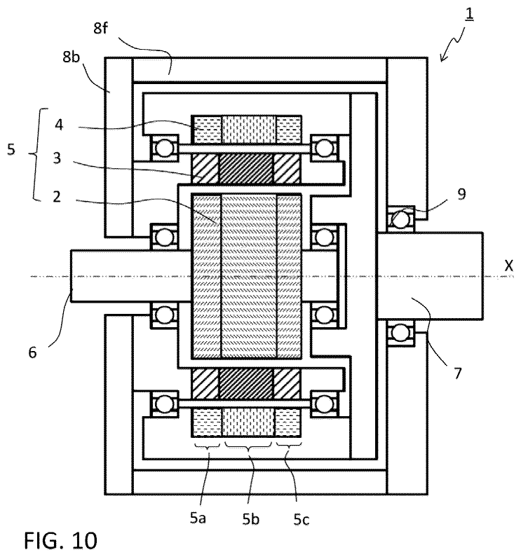

In Embodiment 1 and Embodiment 2, the examples in which the magnetic gear part with the two-stage structure where the first section and the second section are connected in the axial direction have been described. In Embodiment 3, an example having a magnetic gear part with a three-stage structure will be described. FIG. 10 is a cross-sectional view that is taken along a rotation axis and includes the rotation axis in the magnetic gear for describing a configuration and an operation of a magnetic gear according to Embodiment 3. Note that a third magnetic gear part is arranged in the same manner (in the same phase) as the first section, and the first section and the second section are arranged in the same manner as described in Embodiment 1 or Embodiment 2. Therefore, description thereof will be omitted, and FIG. 2A to FIG. 9B will be referred to.

In the magnetic gear 1 according to Embodiment 3, as illustrated in Embodiment 1 or Embodiment 2, the second section 5b different in the phase from the first section 5a in at least one of the fewer-pole mechanism 2, the multi-pole mechanism 4, and the polepiece 3 is adjacent to the first section 5a to each other in the axial direction. As shown in FIG. 10, in the opposite side of the second section 5b with respect to the first section 5a in the axial direction, a third section 5c in which each mechanism is arranged in the same phase as the first section 5a is connected to form the three-stage structure.

The present embodiment is different from Embodiment 1 or Embodiment 2 in that the number of adjacent portions of sections having different phases is two, whereas the number of adjacent portions of sections having different phases is one in Embodiment 1 or Embodiment 2, and the other configurations are the same as those of Embodiment 1 or Embodiment 2. By disposing the sections having different phases (the first section 5a, the second section 5b, and the third section 5c) so as to be arranged and dispersed in the axial direction, it is possible to suppress deflection in a direction perpendicular to the axial direction due to a bending moment generated by the combination of electromagnetic excitation forces having different phases in the circumferential direction.

With regard to the distribution of regions in the axial direction about the sections having arrangements with different phases, a configuration in which the effect of suppressing the deflection is optimal differs depending on the positional relationship between the rotor and the bearing 9 or fastening positions with respect to the load and the rotating electrical machine. FIG. 10 shows, as an example, a configuration in which the ratio of stacking thicknesses of the first section 5a, the second section 5b, and the third section 5c in the axial direction is 1:2:1. From the viewpoint of canceling out the electromagnetic excitation forces, it is desirable that the stacking thicknesses in the axial direction in an arrangement pattern A by the first section 5a and the third section 5c coincides with the stacking thicknesses in the axial direction in an arrangement pattern B by the second section 5b.

In Embodiment 3, the example in which the magnetic gear part 5 is configured by connecting three sections in the axial direction has been described. However, even in a case where four or more sections are provided, it is possible to further reduce the deflection in the direction perpendicular to the axial direction, and the same effect can be obtained. Further, in Embodiment 3, the configuration example in which the sections of two kinds of the arrangement patterns are connected in the axial direction is shown, but the same effect can be obtained by combining more kinds of sections to cancel the electromagnetic excitation forces by the addition of the vectors.

### Embodiment 4

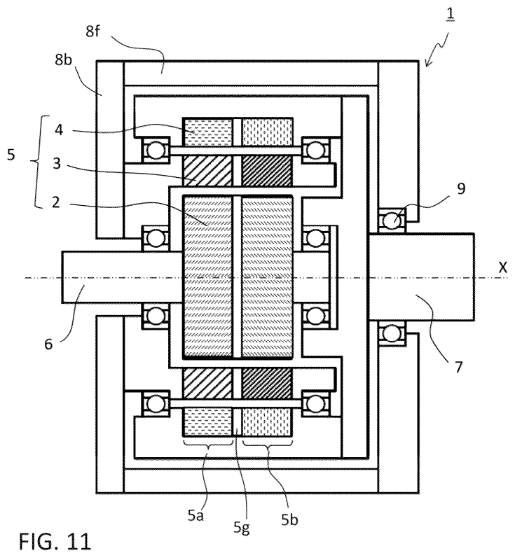

In Embodiment 1 and Embodiment 2 described above, the examples have been described in which the first section and the second section are connected in close contact with each other in the axial direction to form the magnetic gear part. In Embodiment 4, an example in which the first section and the second section are connected to each other via a magnetic hollow portion to form a magnetic gear part will be described. FIG. 11 is a cross-sectional view that is taken along the rotation axis and includes the rotation axis in the magnetic gear for describing a configuration and an operation of a magnetic gear according to Embodiment 4. Note that the arrangement of the mechanisms in each of the first section and the second section is the same as the arrangement described in Embodiment 1 or Embodiment 2, and the description thereof will be omitted, and FIG. 2A to FIG. 9B will be referred to.

As shown in FIG. 11, the magnetic gear 1 according to Embodiment 4 is the same as that of Embodiment 1 or Embodiment 2 except that a magnetic hollow portion 5g using air, a non-magnetic material, or the like is provided between the first section 5a and the second section 5b in the axial direction. By providing the magnetic hollow portion 5g between the first section 5a and the second section 5b having different phases, it is possible to reduce leakage flux in the axial direction that does not contribute to the torque transmission of the magnetic gear 1. Therefore, it is possible to suppress a decrease in the transmission torque due to the formation of the magnetic gear part 5 by connecting the sections having different phases (the first section 5a and the second section 5b).

### Variation Example

Although FIG. 10 shows the example in which the small magnetic hollow portion 5g is provided in the axial direction in order to reduce the size of the magnetic gear 1, this is not a limitation. Even when the first section 5a and the second section 5b are separated from each other in the axial direction and are connected to each other by a structural member to secure the magnetic hollow portion 5g, the same effect can be obtained. Further, the first section 5a and the second section 5b may be sections formed of different structural members, and each of the rotors (in this example, the multi-pole mechanism 4 and the fewer-pole mechanism 2) may be connected to each other by a structural member.

### Embodiment 5

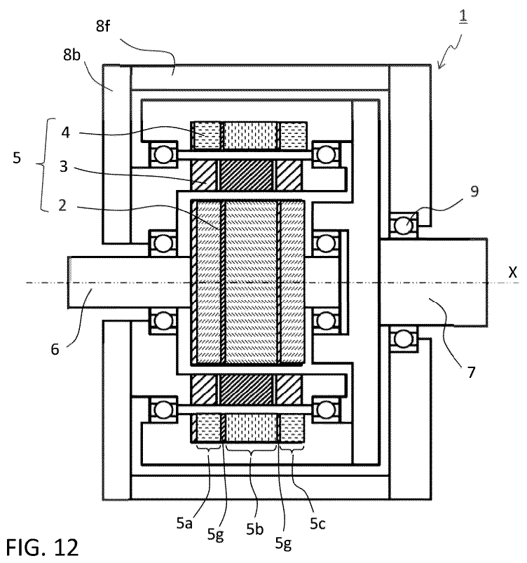

In Embodiment 5, the magnetic hollow portion is provided between the sections as in Embodiment 4 with respect to the magnetic gear part in which the three sections described in Embodiment 3 are connected. FIG. 12 is a cross-sectional view that is taken along the rotation axis and includes the rotation axis in the magnetic gear for describing a configuration and an operation of a magnetic gear according to Embodiment 5. Note that the arrangement of the mechanism in each of the first section, the second section, and the third section is the same as that described in Embodiment 3, and thus description thereof will be omitted, and FIG. 2A to FIG. 9B will be referred to.

As shown in FIG. 12, the magnetic gear 1 according to Embodiment 5 is the same as that of Embodiment 3 except that the magnetic hollow portion 5g using air, a non-magnetic material, or the like is provided between the first section 5a and the second section 5b, and between the second section 5b and the third section 5c in the axial direction using. By arranging the first section 5a, the second section 5b, and the third section 5c having different phases so as to be arranged and dispersed in the axial direction, deflection in a direction perpendicular to the axial direction is suppressed. In addition, it is possible to reduce the leakage flux in the axial direction that does not contribute to the torque transmission of the magnetic gear 1 by providing the magnetic hollow portion 5g to exist each between them.

### Variation Example

Although FIG. 12 shows an example in which the small magnetic hollow portion 5g is provided in the axial direction in order to reduce the size of the magnetic gear 1, this is not a limitation. The same effect can be obtained even with a configuration in which the first section 5a, the second section 5b, and the third section 5c are further separated from each other in the axial direction, and the magnetic hollow portion 5g is secured by connecting them with a structural member.

Further, the first section 5a, the second section 5b, and the third section 5c may be sections formed of different structural members, and each of the rotors (in the present example, the multi-pole mechanism 4 and the fewer-pole mechanism 2) may be connected to each other by a structural member. Further, in the same manner as in Embodiment 3, the example in which the sections of the two kinds of the arrangement patterns are connected in the axial direction is shown, but the same effect can be obtained by combining more kinds of sections to cancel the electromagnetic exciting forces by the addition of the vectors.

### Embodiment 6

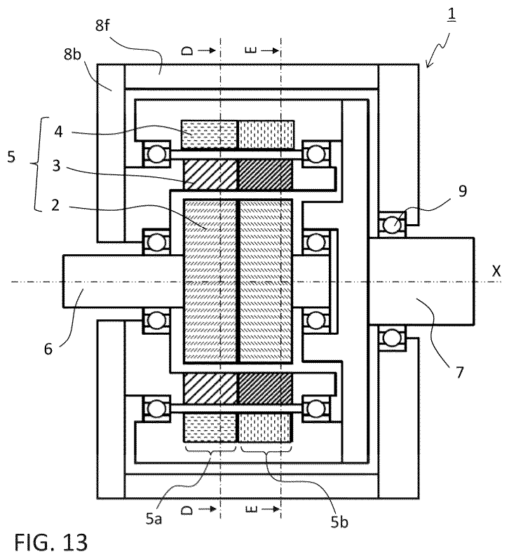

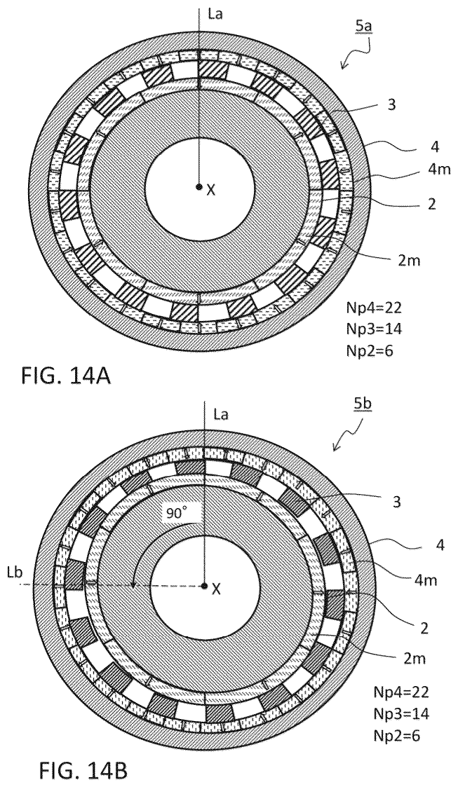

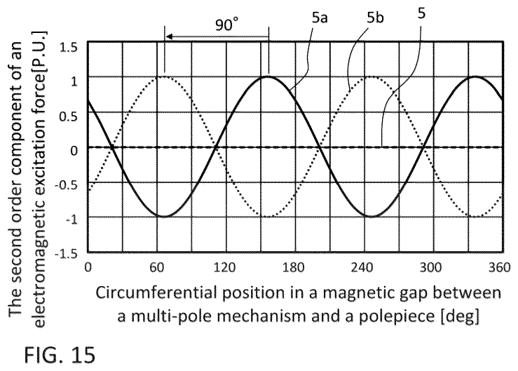

In a magnetic gear according to Embodiment 6, an example in which a magnetic gear part is configured by a combination of the number of polarities different from those in Embodiment 1 to Embodiment 5 will be described. FIG. 13 to FIG. 15 are diagrams for describing a configuration and an operation of a magnetic gear according to Embodiment 6, and FIG. 13 is a cross-sectional view that is taken along the rotation axis, includes the rotation axis, and shows the configuration of the magnetic gear, FIG. 14A is a cross-sectional view perpendicular to the rotation axis in the first section, corresponding to a line D-D of FIG. 13, and FIG. 14B is a cross-sectional view perpendicular to the rotation axis in the second section, corresponding to a line E-E of FIG. 13. FIG. 15 is a diagram showing a relationship of the electromagnetic excitation forces of the first order components of the first section, the second section, and the entire gear part with respect to the circumferential position in the magnetic gap between the multi-pole mechanism and the polepiece in the magnetic gear part.

In the magnetic gear 1 according to Embodiment 6, as shown in FIG. 13 and FIG. 14A, the section is constituted by the multi-pole mechanism 4 in which 22 (number of poles Np4) permanent magnets 4m are arranged, the fewer-pole mechanism 2 in which 6 (number of poles Np2) permanent magnets 2m are arranged, and the polepiece 3 constituted by 14 (number of poles Np3) magnetic pole pieces.

That is, the gear ratio of the magnetic gear 1 when the polepiece 3 is fixed is 3.67 that is (22/2)/(6/2). The greatest common divisor of the number of poles Np2 of the fewer-pole mechanism 2 and the number of poles Np3 of the polepiece 3, and the greatest common divisor of the number of poles Np4 of the multi-pole mechanism 4 and the number of poles Np3 of the polepiece 3 are both 2. Since the greatest common divisor of the number of poles is 2, the least common multiple of the number of poles can be made sufficiently large as in Embodiment 1, and the amplitude of the cogging torque can be reduced.

As shown in FIG. 14B, the second section 5b has a shape obtained by rotating the second section 5b with respect to the first section 5a by 90 degrees in the mechanical angle with reference to the line segment La. The present embodiment is the same as Embodiment 1 to Embodiment 5 described above except that the first section 5a is replaced from the arrangement shown in FIG. 2A to the arrangement shown in FIG. 14A, and the second section 5b is replaced from the arrangement shown in FIG. 2B to the arrangement shown in FIG. 14B.

In the configuration of the number of poles shown in Embodiment 6, since the spatial symmetry is second order, an electromagnetic excitation force having a spatial second order mode in the circumferential direction is generated. As shown in FIG. 15, since the first section 5a and the second section 5b have the phase difference of 90 degrees in the mechanical angle, it is understood that the spatial waveforms of the second order components of the electromagnetic excitation forces generated in the multi-pole mechanism 4 cancel each other owing to the phase relationship of the second order electromagnetic excitation forces when they are added together.

### Variation Example

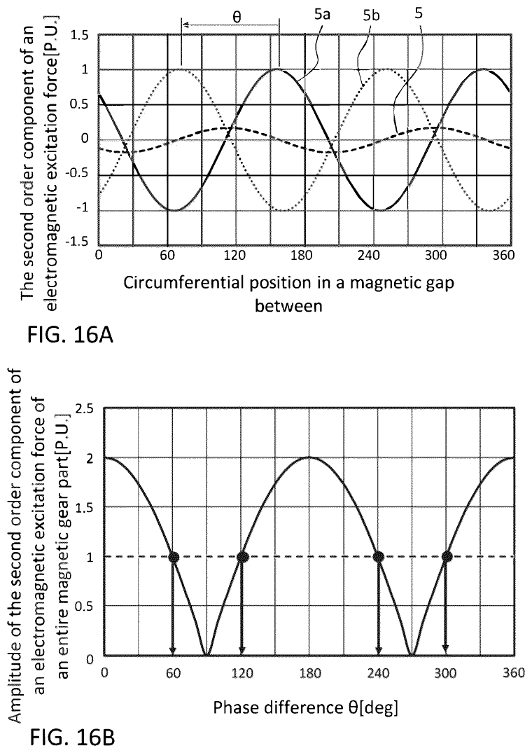

FIG. 16A is a diagram showing a relationship of the circumferential position in the magnetic gap between the multi-pole mechanism and the polepiece in the magnetic gear part with respect to the second order components of the electromagnetic excitation forces according to a variation example of Embodiment 6, and FIG. 16B is a diagram showing a relationship between the phase difference (phase shift) of the two sections and the amplitude of the second order component of the electromagnetic excitation force of the entire magnetic gear part.

In the present variation example, it will be described that the same effect can be obtained even when the phase difference of the mechanical angle is other than 90 degrees. In the arrangement of the second section 5b, the angle of the line segment Lb with respect to the line segment La shown in FIG. 14B is changed from 90 degrees to θ. That is, the case where θ is 90 degrees corresponds to the arrangement shown in FIG. 14B described in Embodiment 6, and the present variation example shows a configuration in which the rotation angle is generalized.

As shown in FIG. 16A, it can be seen that even when the phase difference θ is not 90 degrees, the amplitude of the spatial second order component of the electromagnetic excitation force can be made smaller by the addition than the amplitude in the case where the each of the sections is used alone. The amplitude of the spatial second order component of the electromagnetic excitation force when the phase difference θ is changed from 0 to 360 degrees changes as shown in FIG. 16B. When the phase difference θ is in a range larger than 60 degrees and smaller than 120 degrees or in a range larger than 240 degrees and smaller than 300 degrees, the amplitude of the spatial second order component of the electromagnetic excitation force can be reduced as compared with the case where each section is used alone.

### Another Variation Example

In Embodiment 6 and the variation example thereof, an example in which the polepiece 3 is fixed has been described. However, a configuration in which the polepiece 3 is configured to be freely rotatable and thus the phase can be freely adjusted may be employed. Further, as the configuration of the magnetic gear part 5, the example in which the two types of sections shown in FIG. 1 of Embodiment 1 are connected in close contact with each other in the axial direction has been shown, but this is not a limitation. The same effect can be obtained with the configurations similar to Embodiment 3 to Embodiment 5.

### Embodiment 7

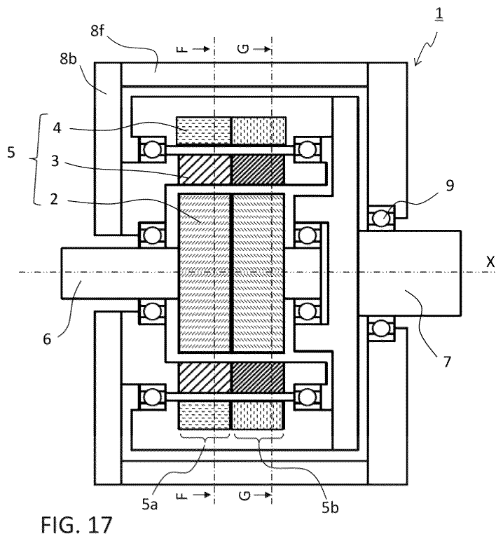

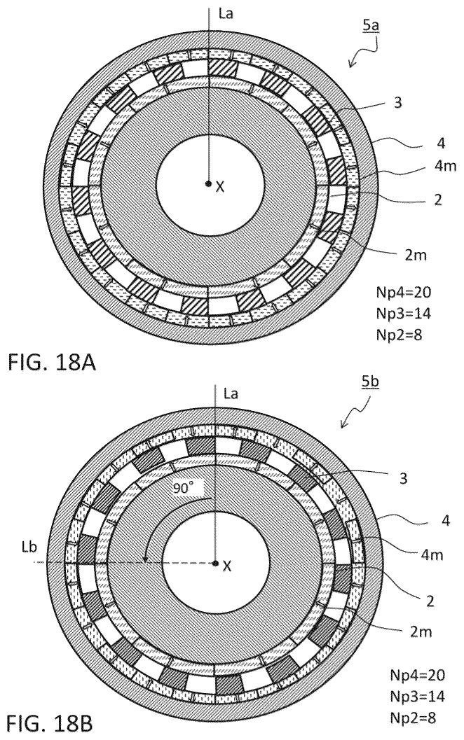

In a magnetic gear according to Embodiment 7, an example in which a magnetic gear part is configured by a combination of the number of polarities different from those in Embodiment 1 to Embodiment 5, and Embodiment 6 will be described. FIG. 17, FIG. 18A, and FIG. 18B are for describing a configuration and an operation of a magnetic gear according to Embodiment 7, FIG. 17 is a cross-sectional view that is taken along the rotation axis, includes the rotation axis, and shows the configuration of the magnetic gear, FIG. 18A is a cross-sectional view perpendicular to the rotation axis in the first section, corresponding to a line F-F of FIG. 17, and FIG. 18B is a cross-sectional view perpendicular to the rotation axis in the second section, corresponding to a line G-G of FIG. 17.

As shown in FIG. 17 and FIG. 18A, in the magnetic gear 1 according to Embodiment 6, a section is constituted by the multi-pole mechanism 4 in which 20 (number of poles Np4) permanent magnets 4m are arranged, the fewer-pole mechanism 2 in which 8 (number of poles Np2) permanent magnets 2m are arranged, and the polepiece 3 constituted by 14 (number of poles Np3) magnetic pole pieces.

That is, when the polepiece 3 is fixed, the gear ratio of the magnetic gear 1 is 2.5 that is (20/2)/(8/2). The greatest common divisor of the number of poles Np2 of the fewer-pole mechanism 2 and the number of poles Np3 of the polepiece 3, and the greatest common divisor of the number of poles Np4 of the multi-pole mechanism 4 and the number of poles Np3 of the polepiece 3 are both 2. Since the greatest common divisor of the number of poles is 2, the least common multiple of the number of poles can be made sufficiently large as in Embodiment 6, and the amplitude of the cogging torque can be reduced.

As shown in FIG. 18B, the second section 5b has a shape obtained by rotating the first section 5a by 90 degrees in the mechanical angle with reference to the line segment La. The present embodiment is the same as Embodiment 1 to Embodiment 5 described above except that the first section 5a is replaced from the arrangement shown in FIG. 2A to the arrangement shown in FIG. 18A, and the second section 5b is replaced from the arrangement shown in FIG. 2B to the arrangement shown in FIG. 18B.

The phase of the fewer-pole mechanism 2 of the second section coincides with that of the first section 5a, and similarly to Embodiment 1, the fewer-pole mechanism 2 does not require the stacking in the axial direction with the phase shift., and thus manufacturing equipment can be shared with the first section 5a. Therefore, the manufacturing equipment for the stacking with the phase shift is unnecessary, and an increase in manufacturing cost can be suppressed. Although the example in which the phase of the fewer-pole mechanism 2 coincides between the first section 5a and the second section 5b has been described in the present embodiment, this is not a limitation. The same effect can be obtained by a combination of the number of poles and the phase difference θ such that an arrangement pattern where the phase of at least one of the fewer-pole mechanism 2 and the multi-pole mechanism 4 is different is arranged two or more in the axial direction. In the configuration of the number of poles shown in Embodiment 6, since the spatial symmetry is second order, an electromagnetic excitation force having a spatial second order mode in the circumferential direction is generated. As shown in FIG. 15, since the first section 5a and the second section 5b have the phase difference of 90 degrees in the mechanical angle, it is understood that the spatial waveforms of the second order components of the electromagnetic excitation forces generated in the multi-pole mechanism 4 cancel each other owing to the phase relationship of the second order electromagnetic excitation forces when they are added together.

### Variation Example

In Embodiment 7, the example in which the polepiece 3 is fixed has been described. However, a configuration in which the polepiece 3 is configured to be freely rotatable, and thus the phase can be freely adjusted may be employed. Further, as the configuration of the magnetic gear part 5, the example in which the two types of sections shown in FIG. 1 of Embodiment 1 are connected in close contact with each other in the axial direction has been shown, but this is not a limitation. The same effect can be obtained with the configurations similar to Embodiment 3 to Embodiment 5.

Although various exemplary embodiments are described in the present application, various features, aspects, and functions described in one or more embodiments are not inherent in an application of the contents disclosed in a particular embodiment, and can be applicable alone or in their various combinations to each embodiment. Accordingly, countless variations that are not illustrated are envisaged within the scope of the art disclosed in the specification of the present application. For example, the case where at least one component is modified, added or omitted, and the case where at least one component is extracted and combined with a component disclosed in another embodiment are included.

For example, the examples in which the permanent magnet (permanent magnets 4m and permanent magnets 2m) of each magnetic pole in the magnetic gear 1 is one for each pole have been described, but the same effect can be obtained even when the permanent magnet is divided in the magnetizing direction, the orthogonal direction with respect to the magnetizing direction, the axial direction, and other directions. Further, the examples are shown in which the magnetic gear 1 is of a radial type having the magnetic gap portion in a direction perpendicular to the rotation axis X, but the same effect can be obtained in an axial type having a magnetic gap portion in a direction parallel to the rotation axis X.

Further, in each of the above-described embodiments, as a combination of the number of poles Np2, the number of poles Np4, and the number of poles Np3, a total of three combinations of the number of poles such as the combination example of 6, 28, and 17, the combination example of 6, 22, and 14, and the combination example of 8, 20, and 14 have been shown, but this is not a limitation. Further, the cases where the greatest common divisor of the number of poles Np2 and the number of poles Np3 and the greatest common divisor of the number of poles Np4 and the number of poles Np3 are both 1 or 2 have been described as the examples, but this is not a limitation.

Of course, when both of them are 1, the spatial first order component of the electromagnetic excitation force can be reduced to the maximum, and when both of them are 2, the spatial second order component of the electromagnetic excitation force can be reduced to the maximum. Further, even when one of them is 1 and the other thereof is 2, it is possible to reduce each of the spatial first order component and the spatial second order component of the electromagnetic excitation force. Furthermore, when one of them is 1 or 2, even when the other thereof is neither 1 nor 2, it is possible to reduce the spatial first order component or the spatial second order component of the electromagnetic excitation force.

In view of the above, the same effect can be obtained as long as at least the following three conditions are satisfied at the same time.
Condition 1: Two or more sections in which at least one of the polepiece 3, the fewer-pole mechanism 2, and the multi-pole mechanism 4 has a different phase are arranged in the axial direction.
Condition 2: At least one of the greatest common divisor of the number of poles Np2 of the fewer-pole mechanism 2 and the number of poles Np3 of the polepiece 3 and the greatest common divisor of the number of poles Np4 of the multi-pole mechanism 4 and the number of poles Np3 is 1 or 2.
Condition 3: When the number of pole pairs (=Np2/2) of the fewer-pole mechanism 2 constituting the section is N₂, the number of pole pairs (=Np4/2) of the multi-pole mechanism 4 is N₄, and the number of the polepieces 3 (=Np3) is N₃, a relationship represented by Expression (1) is established.

$$( 2 k - 1 ) {N}_{3} = {N}_{4} \pm ( 2 m - 1 ) {N}_{2} \qquad ( 1 )$$

where both k and m are natural numbers.

In addition, the shapes of the teeth of the magnetic gear 1, the polepiece 3, and the permanent magnets (the permanent magnets 2m and the permanent magnets 4m) are all illustrated as the simplest shapes, but are not limited thereto. The shapes of the teeth and the polepiece may be widened or narrowed in the radial direction toward the magnetic gap portion. Further, even in a case where bond magnets are used as the permanent magnets, when two or more permanent magnets are used per magnetic pole and embedded in a V-shape, the same effect can be obtained regardless of the shapes of the teeth, the polepiece 3, and the permanent magnets as long as the above-described three conditions are satisfied.

As described above, the magnetic gear of the present application includes the magnetic gear part 5 configured such that each of the multi-pole mechanism 4, the fewer-pole mechanism 2, and the polepiece 3 shares a function of any one of the stator, a first rotor, and a second rotor, the multi-pole mechanism 4 having the magnetic poles of the first pole numbers (the number of poles Np4) arranged along the circumferential direction with the permanent magnets 4m, the fewer-pole mechanism 2 having the magnetic poles of the second pole numbers (the number of poles Np2) that are fewer than those of the first pole numbers (the number of poles Np4) and are arranged along the circumferential direction with the permanent magnets 2m, the polepiece 3 having the magnetic poles of the third pole numbers (the number of poles Np3) arranged along the circumferential direction with soft magnetic material through the magnetic gaps with respect to each of the magnetic poles of the multi-pole mechanism 4 and of the fewer-pole mechanism 2; a first shaft (multi-pole rotor shaft 7) to transmit torque between the first rotor (for example, the multi-pole mechanism 4) and an outside; and a second shaft (for example, few-pole rotor shaft 6) to transmit torque between the second rotor and the outside. The magnetic gear part 5 is configured such that, between adjacent sections (for example, the first section 5a and the second section 5b, the second section 5b and the third section 5c) among a plurality of sections (for example, the first section 5a, the second section 5b, the third section 5c) divided along an axial direction (the direction of the rotation axis X), the positional relationship of the magnetic poles among the multi-pole mechanism 4, the fewer-pole mechanism 2, and the polepiece 3 is different in such a way that at least one of the multi-pole mechanism 4, the fewer-pole mechanism 2, and the polepiece 3 has the phase difference θ, and at least one of the greatest common divisor of the first pole numbers (the number of poles Np4) and the third pole numbers (the number of poles Np3) and the greatest common divisor of the second pole numbers (the number of poles Np2) and the third pole numbers (the number of poles Np3) is 1 or 2. Therefore, it is possible to achieve both a reduction in the cogging torque and a reduction in the electromagnetic excitation force without increasing manufacturing cost.

In particular, when surfaces extending in the axial direction of the permanent magnets (the permanent magnets 4m and the permanent magnets 2m) used respectively in the multi-pole mechanism 4 and the fewer-pole mechanism 2 are parallel to the axial direction, the magnetic poles can be formed without performing special processing.

Here, at least one of the greatest common divisor of the first pole numbers and the third pole numbers and the greatest common divisor of the second pole numbers and the third pole numbers is 1, and the plurality of sections are constituted by two types of sections including a section in a first arrangement pattern (for example, the first section 5a) in which the magnetic poles are arranged in the first positional relationship and a section in a second arrangement pattern (for example, the second section 5a) in which the magnetic poles are arranged in the second positional relationship in which the phase difference θ with respect to the section in the first arrangement pattern (for example, the first section 5a, the third section 5c) are in an angle range greater than 120 degrees and less than 240 degrees on the mechanical angle basis, as the positional relationship of the magnetic poles, and then the spatial first order component of the electromagnetic excitation force can be effectively reduced.

Alternatively, at least one of the greatest common divisor of the first pole numbers and the third pole numbers and the greatest common divisor of the second pole numbers and the third pole numbers is 1, and the plurality of sections are constituted by two types of sections including a section in a first arrangement pattern (for example, the first section 5a) in which the magnetic poles are arranged in the first positional relationship and a section in a second arrangement pattern (for example, the second section 5a) in which the magnetic poles are arranged in the second positional relationship in which the phase difference θ with respect to the section in the first arrangement pattern (for example, the first section 5a, the third section 5c) are in an angle range greater than 60 degrees and less than 120 degrees or greater than 240 degrees and less than 300 degrees on a mechanical angle basis, as the positional relationship of the magnetic poles, and then the spatial second order component of the electromagnetic excitation force can be effectively reduced.

Further, when the magnetic hollow portion 5g is provided between adjacent sections (for example, the first section 5a and the second section 5b) among the plurality of sections, it is possible to reduce the leakage flux between adjacent sections so that a decrease in the transmission torque can be suppressed.

When three or more sections (for example, the first section 5a, the second section 5b, the third section 5c) that are divided are provided as the plurality of sections, the order of vibration mode of bending force in the axial direction can be increased to reduce bending force.

In this case, when at least two sections (for example, the first section 5a and the third sections 5c) among the three or more sections have the same positional relationship in the magnetic poles among the multi-pole mechanism 4, the fewer-pole mechanism 2, and the polepiece 3, the order of vibration mode of bending force in the axial direction can be increased to reduce bending force without increasing the number of kinds of components and complicating the process.

### DESCRIPTION OF REFERENCE NUMERALS AND SIGNS

1: magnetic gear, 2: fewer-pole mechanism, 2m: permanent magnet, 3: polepiece, 4: multi-pole mechanism, 4m: permanent magnet, 5: magnetic gear part, 5a: first section, 5b: second section, 5c: third section, 6: few-pole rotor shaft (first shaft or second shaft), 7: multi-pole rotor shaft (second shaft or first shaft), Np2: number of poles (second pole numbers), Np3: number of poles (third pole numbers), Np4: number of poles (first pole numbers), X: rotation shaft, θ: phase difference

1. A magnetic gear comprising:
a magnetic gear part configured such that each of a multi-pole mechanism, a fewer-pole mechanism, and a polepiece shares a function of any one of a stator, a first rotor, and a second rotor, the multi-pole mechanism having magnetic poles of first pole numbers arranged along a circumferential direction with permanent magnets, the fewer-pole mechanism having magnetic poles of second pole numbers that are fewer than those of the first pole numbers and are arranged along the circumferential direction with permanent magnets, the polepiece having magnetic poles of third pole numbers arranged along the circumferential direction with soft magnetic material through magnetic gaps with respect to each of the magnetic poles of the multi-pole mechanism and of the fewer-pole mechanism;
a first shaft to transmit torque between the first rotor and an outside; and
a second shaft to transmit torque between the second rotor and an outside, wherein
in the magnetic gear part, between adjacent sections among a plurality of sections divided along an axial direction, the first pole numbers, the second pole numbers, and the third pole numbers are the same with each other, a positional relationship of magnetic poles among the multi-pole mechanism, the fewer-pole mechanism, and the polepiece is different such that at least one of the multi-pole mechanism, the fewer-pole mechanism, and the polepiece has a phase difference, and at least one of a greatest common divisor of the first pole numbers and the third pole numbers and a greatest common divisor of the second pole numbers and the third pole numbers is 1 or 2.

2. The magnetic gear according to claim 1, wherein surfaces of the permanent magnets that extend in the axial direction are parallel to the axial direction, the permanent magnets being used in the multi-pole mechanism and the fewer-pole mechanism.

3. A magnetic gear comprising:
a magnetic gear part configured such that each of a multi-pole mechanism, a fewer-pole mechanism, and a polepiece shares a function of any one of a stator, a first rotor, and a second rotor, the multi-pole mechanism having magnetic poles of first pole numbers arranged along a circumferential direction with permanent magnets, the fewer-pole mechanism having magnetic poles of second pole numbers that are fewer than those of the first pole numbers and are arranged along the circumferential direction with permanent magnets, the polepiece having magnetic poles of third pole numbers arranged along the circumferential direction with soft magnetic material through magnetic gaps with respect to each of the magnetic poles of the multi-pole mechanism and of the fewer-pole mechanism;
a first shaft to transmit torque between the first rotor and an outside; and
a second shaft to transmit torque between the second rotor and an outside, wherein
in the magnetic gear part, between adjacent sections among a plurality of sections divided along an axial direction, a positional relationship of magnetic poles among the multi-pole mechanism, the fewer-pole mechanism, and the polepiece is different such that at least one of the multi-pole mechanism, the fewer-pole mechanism, and the polepiece has a phase difference, and wherein
at least one of a greatest common divisor of the first pole numbers and the third pole numbers and a greatest common divisor of the second pole numbers and the third pole numbers is 1, and
the plurality of sections are constituted by two types of sections including a section in a first arrangement pattern in which the magnetic poles are arranged in a first positional relationship and a section in a second arrangement pattern in which the magnetic poles are arranged in a second positional relationship in which the phase difference with respect to the section in the first arrangement pattern are in an angle range greater than 120 degrees and less than 240 degrees on a mechanical angle basis, as the positional relationship of the magnetic poles.

4. A magnetic gear comprising:
a magnetic gear part configured such that each of a multi-pole mechanism, a fewer-pole mechanism, and a polepiece shares a function of any one of a stator, a first rotor, and a second rotor, the multi-pole mechanism having magnetic poles of first pole numbers arranged along a circumferential direction with permanent magnets, the fewer-pole mechanism having magnetic poles of second pole numbers that are fewer than those of the first pole numbers and are arranged along the circumferential direction with permanent magnets, the polepiece having magnetic poles of third pole numbers arranged along the circumferential direction with soft magnetic material through magnetic gaps with respect to each of the magnetic poles of the multi-pole mechanism and of the fewer-pole mechanism;
a first shaft to transmit torque between the first rotor and an outside; and
a second shaft to transmit torque between the second rotor and an outside, wherein
in the magnetic gear part, between adjacent sections among a plurality of sections divided along an axial direction, a positional relationship of magnetic poles among the multi-pole mechanism, the fewer-pole mechanism, and the polepiece is different such that at least one of the multi-pole mechanism, the fewer-pole mechanism, and the polepiece has a phase difference, and wherein
at least one of a greatest common divisor of the first pole numbers and the third pole numbers and a greatest common divisor of the second pole numbers and the third pole numbers is 2, and
the plurality of sections are constituted by two types of sections including a section in a first arrangement pattern in which the magnetic poles are arranged in a first positional relationship and a section in a second arrangement pattern in which the magnetic poles are arranged in a second positional relationship in which the phase difference with respect to the section in the first arrangement pattern are in an angle range greater than 60 degrees and less than 120 degrees or greater than 240 degrees and less than 300 degrees on a mechanical angle basis, as the positional relationship of the magnetic poles.

5.-6. (canceled)

7. A magnetic gear comprising:
a magnetic gear part configured such that each of a multi-pole mechanism, a fewer-pole mechanism, and a polepiece shares a function of any one of a stator, a first rotor, and a second rotor, the multi-pole mechanism having magnetic poles of first pole numbers arranged along a circumferential direction with permanent magnets, the fewer-pole mechanism having magnetic poles of second pole numbers that are fewer than those of the first pole numbers and are arranged along the circumferential direction with permanent magnets, the polepiece having magnetic poles of third pole numbers arranged along the circumferential direction with soft magnetic material through magnetic gaps with respect to each of the magnetic poles of the multi-pole mechanism and of the fewer-pole mechanism;
a first shaft to transmit torque between the first rotor and an outside; and
a second shaft to transmit torque between the second rotor and an outside, wherein
in the magnetic gear part, between adjacent sections among a plurality of sections divided along an axial direction, a positional relationship of magnetic poles among the multi-pole mechanism, the fewer-pole mechanism, and the polepiece is different such that at least one of the multi-pole mechanism, the fewer-pole mechanism, and the polepiece has a phase difference, and at least one of a greatest common divisor of the first pole numbers and the third pole numbers and a greatest common divisor of the second pole numbers and the third pole numbers is 1 or 2, and wherein
three or more sections that are divided are provided as the plurality of sections, and wherein at least two sections among the three or more sections have the same positional relationship in the magnetic poles.

8. The magnetic gear according to claim 1, wherein a magnetic hollow portion is provided between adjacent sections among the plurality of sections.

9. The magnetic gear according to claim 2, wherein a magnetic hollow portion is provided between adjacent sections among the plurality of sections.

10. The magnetic gear according to claim 3, wherein a magnetic hollow portion is provided between adjacent sections among the plurality of sections.

11. The magnetic gear according to claim 4, wherein a magnetic hollow portion is provided between adjacent sections among the plurality of sections.

12. The magnetic gear according to claim 7, wherein a magnetic hollow portion is provided between adjacent sections among the plurality of sections.
